(19) United States
(12) Patent Application Publication
(10) Pub. No.: US 2026/0270046 A1
(43) Pub. Date: Sep. 10, 2026

(54) GROUP KEY SHARING

(71) Applicant: Arqit Limited, London (GB)

(72) Inventors: Andrew Yeomans, London (GB); Daryl Burns, Gloucestershire (GB)

(21) Appl. No.: 18/873,611

(22) PCT Filed: Jun. 13, 2023
(86) PCT No.: PCT/GB2023/051531

§ 371 Date: Dec. 10, 2024

(30) Foreign Application Priority Data
Jun. 14, 2022 (GB) 2208688.8

(51) Int. Cl. H04L 9/08

(52) U.S. Cl. CPC H04L 9/0833; H04L 9/0852

(57) ABSTRACT

A method for generating a group key for a group of endpoint devices in a communication system that includes the group of endpoint devices and an intermediary device (ID)communicatively lined to each of the endpoint devices by a respective quantum communication channel and a respective classical communication channel, the method includes agreeing, between the ID and each of the endpoint devices, a respective QKD key, Kₙ, over the corresponding quantum communication channel; determining a group key for secure communication within the group of endpoint devices; sending respective group key information from the ID to each of the endpoint devices over the corresponding classical communication channel; and deriving, by each of the endpoint devices, the identity of the group key the respective group key information includes information useable by the corresponding endpoint device to derive the identity of the group key, said information being encrypted with the respective agreed QKD key.

### FIELD OF THE INVENTION

The present application relates to a system, apparatus and method for secure communications based on quantum key exchange/distribution (QKD) protocols for QKD group key sharing, using multiple pairwise keys and/or applications thereto.

### BACKGROUND TO THE INVENTION

Quantum Key Distribution (QKD) is a secure communication method which implements a cryptographic QKD protocol involving components of quantum mechanics for distributing cryptographic keys. It enables two parties to produce a shared random secret key or cryptographic key known only to them, which can then be used to encrypt and decrypt messages. Following the arrival of large-scale quantum computers, classical (e.g., factorisation and discrete-log based) key exchange methods for key agreement will be vulnerable and unable to provide security. Post-quantum algorithms offer an alternative but suffer from the possibility of yet-to-be-discovered mathematical attacks on their foundations. QKD offers unconditionally-secure agreement of keys between two parties which possess an initial amount of shared secret material but, due to its reliance on physical implementations, the possibility of malfunctions or physical attacks remains.

The BB84 QKD protocol is a well-known QKD protocol using photon polarisation bases to transmit information. The BB84 QKD protocol uses a set of bases including at least two pairs of conjugate photon polarisation bases—for example a set of bases including a rectilinear photon basis (e.g. vertical (0°) and horizontal (90°) polarisations) and a diagonal photon basis (e.g. 45° and 135° polarisations) or the circular basis of left-and right-handedness or similar. In the BB 84 protocol, QKD is performed between a sender device or intermediary device, hereinafter referred to as Alice, and a receiver or first device, hereinafter referred to as Bob or Carol in different implementations. The sender device and receiver device are connected by a quantum communication channel that allows quantum information such as quantum states to be transmitted. Further, the sender device and receiver device also communicate over a non-quantum channel, i.e., a (public) classical channel.

In an example implementation, Sheng-Kai Liao et al., “Satellite-to-ground quantum key distribution”, Nature, vol. 549, pp 43-47, 7 Sep. 2017, describes a satellite-based QKD system using the BB84 protocol for distributing keys, where a satellite free-space optical quantum channel is produced using a 300-mm aperture Cassegrain telescope that sends a light beam from a Micius satellite (operating as Alice in this scenario) to a ground station (operating as Bob in this scenario), the ground station using a Ritchey Chretien telescope for receiving the QKD photons over the satellite free-space optical quantum channel.

Although the security of the BB84 protocol comes from judicious use of the quantum and classical communication channels and suitable authentication processes, both the sender (or intermediary device) distributing the cryptographic key and the receiver receiving the cryptographic key know the cryptographic key that the receiver device will eventually use. This means that the sender (or intermediary) distributing the cryptographic key to the receiver has to be a trusted device in a secure location in order for the receiver to be able to trust that they can use the resulting cryptographic key securely. This may be possible in situations where both the sender and receiver use the resulting cryptographic key for cryptographic operations between themselves-for example, for encrypted communications with each other. However, if the sender (or intermediary) is only distributing keys to one or more receivers where each of the receivers intends to use their received cryptographic keys for communication with one or more other receiver devices, then it may not be acceptable-from a security perspective-for the sender (or intermediary) to have access to the resulting cryptographic keys as this would result in an insecure system that cannot be trusted. These issues may be further exacerbated in the context of group messaging in a group of more than two devices where a single group key is shared multiple times.

Additionally, in the context of group key sharing, implementing group key sharing can be an operation that ranges from trivially simple to incredibly complex, depending on the configuration of the cryptographic system and the assumptions made in the key agreement and sharing processes. A particular challenge facing any group key distribution system is that of authenticating each of the entities (people and/or systems) within the group, and then securely setting up the required encrypted channels between the entities. If suitable authentication and control processes are not in place, then group members cannot reasonably be expected to trust the group. This issue may be particularly prevalent in commercial group systems such as Whatsapp® group messaging in which anyone in a group may invite others to the group. Changes to a group's membership in such systems may occur without permission being sought from each of the members of the group which, in many implementations, may represent a significant security risk.

Therefore, it is clear that there is a desire for an improved secure group communication system that leverages the advantages of QKD and post-quantum cryptographic algorithms in a more secure manner than previously achieved. There is also a desire for a group key sharing system that is capable of sharing identical cryptographic keys between multiple end-points without allowing any other (untrusted) parts of the system to have access to the shared key, or to portions of said key. Furthermore, there is a desire for a group key sharing system that does not rely on the intermediary device being a fully trusted device, i.e., a system where the intermediary device does not need to be fully trusted by all of the devices in the group. In other words, there is a need for a system where the intermediary device does not have enough information to be able to derive or determine the group key shared between the multiple end-point devices.

The invention of the present disclosure builds upon the inventions devised and disclosed in GB2590064B, the entirety of which is hereby incorporated by reference.

The inventors have devised the claimed invention in light of the above considerations.

The embodiments described below are not limited to implementations which solve any or all of the disadvantages of the known approaches described above.

### SUMMARY OF INVENTION

This Summary is provided to introduce a selection of concepts in a simplified form that are further described below in the Detailed Description. This Summary is not intended to identify key features or essential features of the claimed subject matter; variants and alternative features which facilitate the working of the invention and/or serve to achieve a substantially similar technical effect should be considered as falling into the scope of the invention.

In a general sense, the present disclosure provides methods systems and apparatuses for use in the secure agreement of group keys in which the group key(s) are shared between multiple end-point devices, said multiple-endpoint devices being used to create the group key(s) that is/are distributed in such a manner that no other untrusted part of the system has access to sufficient information to be able to derive or determine the group key(s) and/or portions of said group key(s).

The invention is defined as set out in the appended set of claims.

In a first aspect of the present invention, there is provided a computer-implemented method of generating a group key for a group of endpoint devices in a communication system comprising the group of endpoint devices and an intermediary device, the intermediary device being communicatively linked to each of the endpoint devices by a respective quantum communication channel and a respective classical communication channel, the method comprising: agreeing, between the intermediary device and each of the endpoint devices, a respective QKD key, Kₙ, over the corresponding quantum communication channel; determining a group key for secure communication within the group of endpoint devices; sending, from the intermediary device to each of the endpoint devices over the corresponding classical communication channel, respective group key information, wherein the respective group key information comprises information useable by the corresponding endpoint device to derive the identity of the group key, said information being encrypted with the respective QKD key agreed between the intermediary device and the corresponding endpoint device; and deriving, by each of the endpoint devices, the identity of the group key.

In this way, the group key can be distributed amongst the group of endpoint devices in a quantum-secure way.

In some embodiments, the group of endpoint devices may further comprise a first endpoint device; wherein determining the group key comprises determining the group key at the first endpoint device; and respective group key information is not sent to the first endpoint device. Any of the endpoint devices amongst the group of endpoint devices could operate as the so-called first endpoint device. In this way, the methods and systems disclosed herein can be implemented flexibly across a wide variety of networked systems.

In some embodiments, determining the group key may comprise: determining that the QKD key agreed between a or the first endpoint device and the intermediary device is the group key. In this way, the quantum-secure nature of the QKD key agreed between the first endpoint device and the intermediary device can be leveraged to provide a highly secure group key.

In some embodiments, the information useable to derive the identity of the group key may comprise the group key. In this way, the identity of the group key may be more easily derivable.

In some embodiments, determining the group key may comprise: determining a new encryption key, K₀, as being the group key. Further, in some embodiments, the new encryption key may be a randomly generated string of bits. In this way, provided the group key is sufficiently encrypted, it will be exceptionally difficult for a third party to illicitly obtain or derive the identity of the group key.

In some embodiments, the method further may comprise: sending, from the first endpoint device to the intermediary device, a copy of the group key, K₀, encrypted with the QKD key agreed between the first endpoint device and the intermediary device; and creating, by the intermediary device, the respective group key information to be sent to each endpoint device other than the first endpoint device, wherein the group key information comprises the group key. Further, in some embodiments, the method may further comprise: after receiving the encrypted copy of the encryption key, and before creating the respective group key information: decrypting the encrypted copy of the group key to obtain a copy of the group key. In some embodiments, encrypting and/or decrypting the copy of the group key may comprise performing an XOR operation of the group key or encrypted group key with the QKD key agreed between the first endpoint device and the intermediary device. In this way, the intermediary device may be able to distribute the QKD key to each of the other endpoint devices in a secure manner, with each endpoint device receiving its own unique group key information.

In some embodiments, the method may further comprise: sending, from the first endpoint device to each of the other endpoint devices over a corresponding inter-endpoint device communication channels, a copy of the group key, K₀, encrypted with the QKD key agreed between the first endpoint device and the intermediary device, wherein the information useable to derive the identity of the group key comprises the QKD key agreed between the first endpoint device and the intermediary device. Further in some embodiments, deriving, by each of the endpoint devices other than the first endpoint device, the identity of the group key comprises: obtaining based on the respective group key information and the respective QKD key, a copy of the QKD key agreed between the first endpoint device and the intermediary device; and deriving the identity of the group key from the encrypted copy of the group key received from the first endpoint device based on the copy of the QKD key agreed between the first endpoint device and the intermediary device. In some embodiments, encrypted and/or decrypting each copy of the group key, K₀, sent from the first endpoint device to each of the other endpoint devices comprises performing an XOR operation between the copy of the group key and the QKD key agreed between the first endpoint device and the intermediary device. In this way, secure distribution of the group key amongst the group of endpoint devices is possible even when the intermediary device is not a trusted member of the group because the intermediary device is never privy to the identity of the group key.

In some embodiments, the inter-endpoint device communication channels may be classical communication channels. Such channels may simpler and less costly to establish.

In another aspect, there is provided a computer-implemented method for generating a group key for a group of endpoint devices in a communication system, the method being performable by an intermediary device communicatively linked to each of the endpoint devices by a respective quantum communication channel and a respective classical communication channel, the method comprising: agreeing, with each of the endpoint devices, a respective QKD key, Kₙ, over the corresponding quantum communication channel; and sending, to each of the endpoint devices, over the corresponding classical communication channel, respective group key information, wherein the group key information comprises information useable by the corresponding endpoint device to derive the identity of a group key, said information being encrypted with the respective QKD key agreed between the intermediary device and the corresponding endpoint device, and wherein the group key is useable for secure communication within the group of endpoint devices.

In some embodiments, the method may further comprise determining a group key for secure communication within the group of endpoint devices.

In some embodiments, the group of endpoint devices may further comprise a first endpoint device, wherein the group key is determined at the first endpoint device; and respective group key information is not sent to the first endpoint device.

In some embodiments, the group key may be the QKD key agreed between the intermediary device and the first endpoint device.

In some embodiments, the method may further comprise: receiving, from the first endpoint device, a new encryption key, K₀, wherein the new encryption key is the group key. Further, in some embodiments, the new encryption key, K₀, is a randomly generated string of bits.

In some embodiments, receiving the new encryption key may comprise: receiving, from the first endpoint device, an encrypted copy of the group key, encrypted with the QKD key agreed between the first endpoint device and the intermediary device; and decrypting the encrypted copy of the group key to obtain a copy of the group key. Further in some embodiments, decrypting the encrypted copy of the group key may comprise performing an XOR operation of the encrypted group key with the QKD key agreed between the first endpoint device and the intermediary device.

In some embodiments, the information useable to derive the identity of the group key may comprise the group key.

In some embodiments the information useable to derive the identity of the group key may comprise the QKD key agreed between the first endpoint device and the intermediary device.

In some embodiments, the information useable to derive the identity of the group key within the respective group key information may be encrypted with the respective QKD key.

In some embodiments, the respective group key information may be encrypted by performing an XOR operation of the respective group key information with the respective QKD key.

In another aspect there is provided: a computer-implemented method for generating a group key for a group of endpoint devices in a communication system, the method being performable by an endpoint device in the group, said endpoint device being communicatively linked to an intermediary device by a quantum communication channel and a classical communication channel, the method comprising: agreeing, with the intermediary device, a QKD key, Kₙ, over the quantum communication channel; and either: determining a group key for secure communication within the group of endpoint devices; or receiving, from the intermediary device, over the classical communication channel, group key information, wherein the group key information comprises information useable by the endpoint device to derive the identity of a group key for secure communication within the group of endpoint devices, said information being encrypted with the QKD key, and deriving the identity of the group key.

In some embodiments, determining the group key may comprise: determining that the QKD key is the group key.

In some embodiments, the information useable to derive the identity of the group key may comprise the group key.

In some embodiments, determining the group key may comprise: determining a new encryption key, K₀, as being the group key. Further in some embodiments, the new encryption key may be a randomly generated string of bits.

In some embodiments, the method may further comprise: after determining the group key, sending a copy of the group key, K₀, to the intermediary device, wherein the copy of the group key is encrypted with the QKD key agreed between the endpoint device and the intermediary device. Further, in some embodiments, encrypting the copy of the group key may comprise performing an XOR operation of the group key with the QKD key agreed between the endpoint device and the intermediary device.

In some embodiments, the method may comprise: after determining the group key, sending from the endpoint device to each of the other endpoint devices over corresponding inter-endpoint device communication channels, a copy of the group key, K₀, encrypted with the QKD key agreed between the endpoint device and the intermediary device. Further, in some embodiments, encrypting each copy of the group may comprise performing an XOR operation between each copy of the group key and the QKD key agreed with the intermediary device.

In some embodiments, the information useable to derive the identity of the group key may comprise a further QKD key agreed between a further endpoint device amongst the group of endpoint devices and the intermediary device, and the method may further comprise: if receiving group key information from the intermediary device: receiving a copy of the group key from the further endpoint device over an inter-endpoint device communication channel therebetween, the copy of the group key being encrypted with the further QKD key.

In some embodiments, deriving the identity of the group key may comprise: obtaining, based on the group key information and the QKD key agreed between the endpoint device and the intermediary device, a copy of the further QKD key; and deriving the identity of the group key from the encrypted copy of the group key received from the further endpoint device based on the copy of the further QKD key. Further, in some embodiments, decrypting the encrypted copy of the group key may comprise performing an XOR operation between the encrypted copy of the group key and the further QKD key.

In some embodiments, the inter-endpoint device communication channels may be classical communication channels.

In some embodiments, the information useable to derive the identity of the group key within the group key information may be encrypted with the QKD key. Further, in some embodiments, deriving the identity of the group key may comprise decrypting the group key information using the QKD key. In some embodiments, decrypting the group key information may comprise performing an XOR operation of the group key information with the QKD key. In some embodiments, decrypting the group key information may comprise performing and XOR operation of the group key information with the QKD key.

In some embodiments, each encryption key sent form the intermediary device to the or each endpoint device may be a randomly generated string of bits. In this way, the security of the finally agreed key(s) may be increased.

In some embodiments, the intermediary device may be on-board a satellite. In some embodiments, one or more of the endpoint devices may be ground user stations. In some embodiments, one or more of the endpoint devices may comprise optical ground receivers. The methods disclosed herein may be particularly well-suited to Satellite Quantum Key Distribution (SQKD) systems.

In another aspect, there is provided a computing device comprising a processor configured to carry out the methods disclosed herein.

In another aspect, there is provided a networked computing system comprising a plurality of computing devices as disclosed herein, wherein the system is configured to carry out the methods disclosed herein.

In another aspect, there is provided a computer program product comprising logic that, when the program is executed by one or more computers, causes the one or more computers to carry out the methods disclosed herein.

In another aspect, there is provided a computer-readable medium comprising instructions that, when executed by one or more computers, cause the one or more computers to carry out the methods disclosed herein.

The methods described herein may be performed by software in machine readable form on a tangible storage medium e.g. in the form of a computer program comprising computer program code means adapted to perform all the steps of any of the methods described herein when the program is run on a computer and where the computer program may be embodied on a computer readable medium. Examples of tangible (or non-transitory) storage media include disks, thumb drives, memory cards etc. and do not include propagated signals. The software can be suitable for execution on a parallel processor or a serial processor such that the method steps may be carried out in any suitable order, or simultaneously.

This application acknowledges that firmware and software can be valuable, separately tradable commodities. It is intended to encompass software, which runs on or controls “dumb” or standard hardware, to carry out the desired functions. It is also intended to encompass software which “describes” or defines the configuration of hardware, such as HDL (hardware description language) software, as is issued for designing silicon chips, or for configuring universal programmable chips, to carry out desired functions.

The features and embodiments discussed above may be combined as appropriate, as would be apparent to a person skilled in the art, and may be combined with any of the aspects of the invention except where it is expressly provided that such a combination is not possible or the person skilled in the art would understand that such a combination is self-evidently not possible.

### BRIEF DESCRIPTION OF THE DRAWINGS

Embodiments of the present invention are described below, by way of example, with reference to the following drawings.

FIG. 1a is a schematic diagram illustrating an example QKD system for group key sharing according to some embodiments of the invention.

FIG. 1b is a flow diagram illustrating a QKD group key sharing process for use in the QKD system of FIG. 1a.

FIG. 2a is a schematic diagram illustrating a satellite QKD (SQKD) system for group key sharing based on the QKD system of FIG. 1a.

FIG. 2b is a flow diagram illustrating a QKD group key sharing process for use in the SQKD system of FIG. 2a.

FIG. 3a is a schematic diagram illustrating another SQKD system for group key sharing.

FIG. 3b is a flow diagram illustrating a QKD group key sharing process for use in the SQKD system of FIG. 2c.

FIG. 4a is a schematic diagram illustrating another SQKD system for group key sharing.

FIG. 4b is a flow diagram illustrating a QKD group key sharing process for use in the SQKD system of FIG. 4a.

FIG. 5 is a schematic diagram illustrating an example computing device configured to implement the methods described herein.

Common reference numerals are used throughout the figures to indicate the same or similar features.

### DETAILED DESCRIPTION

Embodiments of the present invention are described below by way of example only. These examples represent the best mode of putting the invention into practice that are currently known to the Applicant although they are not the only ways in which this could be achieved. The description sets forth the functions of the example and the sequence of steps for constructing and operating the example. However, the same or equivalent functions and sequences may be accomplished by different examples.

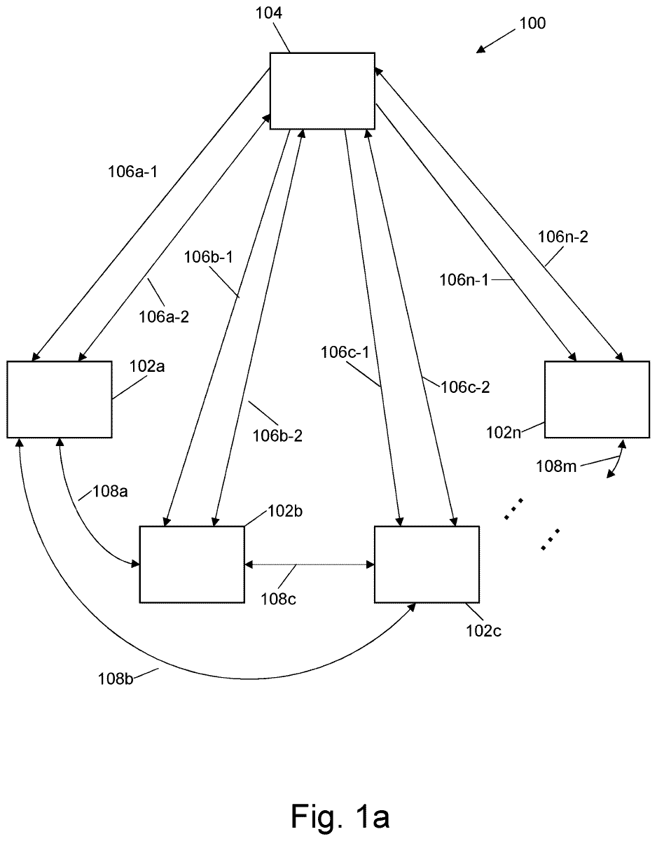

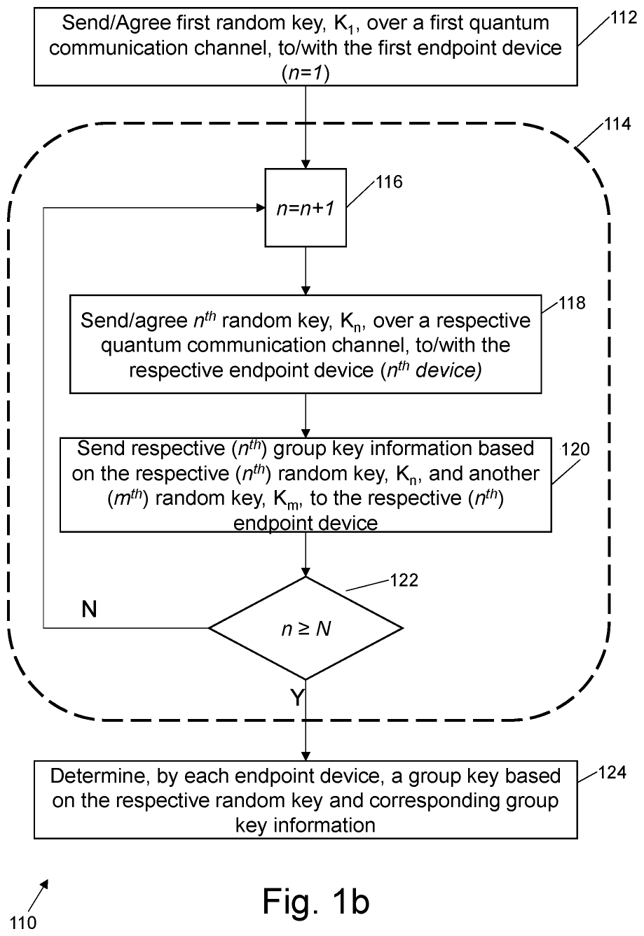

FIG. 1a is a schematic diagram illustrating an example QKD system 100 for group key sharing. The system 100 comprises a plurality of endpoint devices 102a-102n and an intermediary device 104. The plurality of endpoint devices 102a-102n define a group of devices having a number, N, of members-being at least more than two members (i.e., N>2). The intermediary device 104 may be, for example, a satellite or another telecommunications network device/apparatus. The intermediary device 104 is configured to communicate with each of the plurality of endpoint devices 102a-102n over respective quantum communication channels 106a-1 to 106n-1 and respective classical communication channels 106a-2 to 106n-2. In other words, each endpoint device 106a to 106n is communicatively linked to the intermediary device 104 by a respective quantum communication channel 106a-1 to 106n-1 and by a respective classical communication channel 106a-2 to 106n-2. Additionally, each of the endpoint devices 102a-102n is respectively configurable to communicate with each of the other endpoint devices 102a-102n in the group via respective inter-endpoint classical communication channels 108a-108m.

The plurality of inter-endpoint classical communication channels 108a-108m may be used to enable the group of endpoint devices 102a-102n to securely communicate using a shared group key, and to perform key exchange operations during the determination/derivation/agreement of the shared group key.

The intermediary device 104 is configurable to perform a QKD protocol for transmitting respective QKD keys to each of the endpoint devices 102a-102n over the corresponding quantum communication channel 106a-1 to 106n-1. The QKD protocol may provide authentication and an assurance of confidentiality for the details (i.e., the precise identity) of the QKD keys. Each of the quantum communication channels 106a-1 to 106n-1 may be, for example, an optical channel. In such an example, each of the endpoint devices 102a-102n includes the functionality of an optical receiver capable of receiving quantum signals. The received quantum signals may represent an encryption key transmitted over the corresponding quantum communication channels 106a-1 to 106n-1.

In the QKD system 100, the intermediary device 104 is configured to use a corresponding QKD protocol to send a different QKD encryption key (hereinafter referred to as a QKD key) to each of the endpoint devices 102a-102n in the group, together with particular group key information to a plurality of the endpoint devices 102a-102n. The nature of the group key information will be discussed in further detail below. In some implementations, the intermediary device 104 may send the group key information to all of the endpoint devices 102a-102n apart from a first endpoint device 102a representing a so-called first member of the group. The group key information sent to each of the endpoint devices may be respectively different. Each different QKD key may be a randomly generated string of bits generated by a random number generator, or by other similar means. In this sense, each of the QKD keys may be considered to be a ‘random’QKD key.

In order to successfully share a group key, the intermediary device 104 is configured to generate a first encryption key, K₁, and transmit the first key over the first quantum communication channel 106a-1 to the first endpoint device 102a (i.e., n=1, so the 1^{st} endpoint device). The intermediary device 104 is further configured to, simultaneously or subsequently, for each of the other endpoint devices 102b-102n in the group, generate another (n^{th}) encryption key, Kₙ, and transmit each of the encryption keys to a respective endpoint device 102b-102n over a corresponding quantum communication channel 106b-1 to 106n-1.

The transmission of each of the encryption keys over respective quantum communication channels 106a-1 to 106n-1, in effect, achieves the quantum key distribution of each of the encryption keys to their respective endpoint devices 102a-102n. In other words, each of the generated encryption keys, Kₙ, is a QKD key. Further, the transmission of the each of the encryption keys as QKD keys over the corresponding quantum communication channels 106a-1 to 106a-n may include the transmission of basis sets, and error detection and correction over either the corresponding quantum communication channel 106a-1 to 106n-1 and/or the corresponding classical communication channel 106a-2 to 106n-2. Such communications may follow a protocol such as the BB84 protocol or other protocols, such as those devised by the inventors.

Together with each QKD key—except for the first QKD key—the intermediary device 104 is further configured to transmit corresponding group key information to the respective endpoint device 102b-102n via the respective classical communication channel 106b-2 to 106n-2. The corresponding group key information is based on a combination of at least the respective QKD key, Kₙ, and another encryption key. Said other encryption key may, for example, be the first QKD key, K₁, transmitted to the first endpoint device 102a. Each endpoint device 102b-102n may be configured to combine their respectively received QKD key, Kₙ, with the corresponding group key information to derive the group key for communications within the group of endpoint devices 102a-102n.

In particular implementations, the corresponding group key information may comprise the ‘other’ encryption key encrypted with the respective QKD key, Kₙ. In this way, each endpoint device 102a-102n receives their own QKD key and receives a group key for use in communications within the group of endpoint device 102a-102n, wherein the group key is securely encrypted within the corresponding group key information, for example by the respective QKD key that has been agreed between the respective endpoint device 102b-102n and the intermediary device 106.

Various levels of security may be achieved depending on how the respective encryption keys and corresponding group key information are configured and/or transmitted/exchanged between the intermediary device 104 and the endpoint devices 102a-102n. For example, in one scenario, the intermediary device 104 may be considered to be a trusted device such that a group key distribution protocol for determining/deriving/agreeing the group key may allow the QKD keys and/or corresponding group key information to be generated and/or transmitted/configured such that the intermediary device 104 distributes the QKD keys and/or corresponding group key information in a trusted manner. In other words, the intermediary device may be privy to sufficient information to be able to derive the group key.

In alternative scenarios, the intermediary device 104 may be considered to be an untrusted device. In such scenarios, when following the group key distribution protocol, the intermediary device 104 will never be privy to sufficient information to be able to derive the group key.

Various example group key distribution protocols providing alternative solutions to providing a secure group key are disclosed herein.

FIG. 1b is a flow diagram 110 illustrating a QKD group key sharing process for use in the QKD system 100 of FIG. 1a.

A first operation 112 comprises sending, by the intermediary device 104, over a first quantum communication channel 106a-1, data representative of a first encryption key, K₁, to a first endpoint device 102a of the group of endpoint devices 102a-102n. Sending the first encryption key over the first quantum communication channel 106a-1, as discussed above, effectively results in the quantum key distribution of the first encryption key to the first endpoint device 102a.

Subsequently or simultaneously, operation 114 is carried out for each of the other endpoint devices 102b-102n. Operation 114 itself comprises operations 116-122. Operation 116 comprises a logical incrementing of an index, n, that provides the logic required to facilitate carrying out operation 114 for each of the other endpoint devices 102b-102n. Prior to a first iteration of operation 114, the index, n, is initialised with a value of 1. Subsequent to incrementing the index, n, in operation 116, operation 118 is performed.

Operation 118 comprises sending, by the intermediary device 106, a respective encryption key, Kₙ, to the endpoint device 102b-102n corresponding to the value of the index, n, over the corresponding quantum communication channel 106b-1 to 106n-1. In other words, a second encryption key, K₂, is sent to the second endpoint device 102b over the corresponding second quantum communication channel 106b-1 and so on such that a (general) n^{th} encryption key, Kₙ, is sent to a respective n^{th} endpoint device 102n over a corresponding n^{th} quantum communication channel 106n-1. Sending a series of encryption keys to respective endpoint devices 102b-102n over the corresponding quantum communication channels 106b-1 to 106n-1, as discussed above, effectively results in the quantum key distribution of the plurality of encryption keys to their respective endpoint devices 102b-102n. In some examples, the endpoint devices 102a-102n, or the endpoint devices 102b-102n, are assigned their sequence order “first”, “second”, etc. randomly by the intermediary device 104. In other examples-such as examples where the intermediary device 104 is a satellite in orbit around the Earth, the endpoint devices 102a-102n are assigned their sequence order according to the order in which the intermediary device 104 communicates with them, i.e. the first endpoint device 102a is labelled as the first endpoint device because it is the first endpoint device that the intermediary device communicates with as it passes over the plurality of endpoint devices 102a-102n.

Operation 120 comprises sending, by the intermediary device 106, respective group key information, to the endpoint device 102b-102n corresponding to the value of the index, n, over the corresponding classical communication channel 106b-2 to 106n-2. In other words, a ‘second’ item of group key information is sent to the second endpoint device 102b over the corresponding second classical communication channel 106b-2 and so on such that a (general) n^{th} item of group key information is sent to a respective n^{th} endpoint device 102n over a corresponding n^{th} classical communication channel 106n-2. Operation 120 may be performed subsequent to or simultaneously with operation 118. As discussed above, the respective group key information may be based on the respective QKD key, Kₙ, and another QKD key, Kₘ. The other QKD key, Kₘ, may be one of the QKD keys agreed between the intermediary device 106 and another of the endpoint devices 102a-102b.

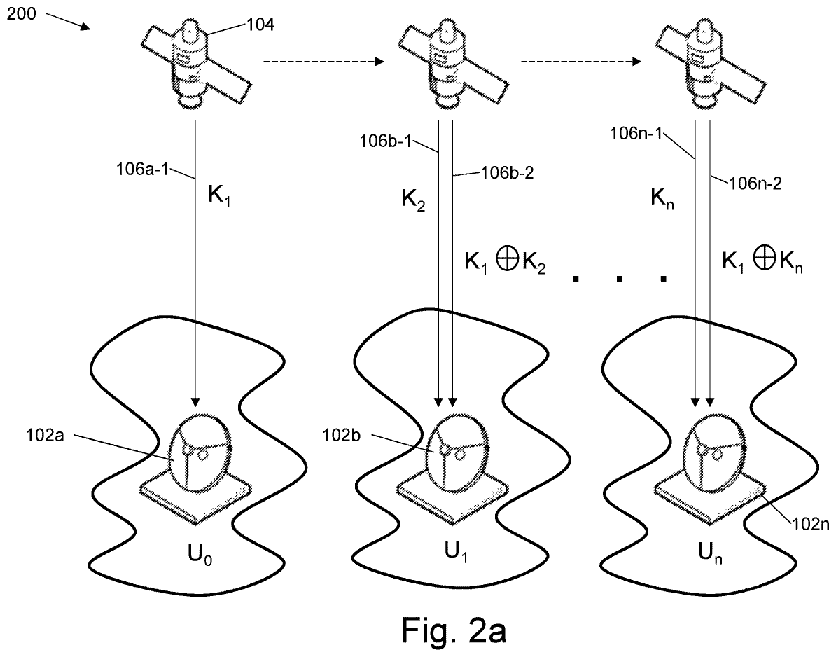

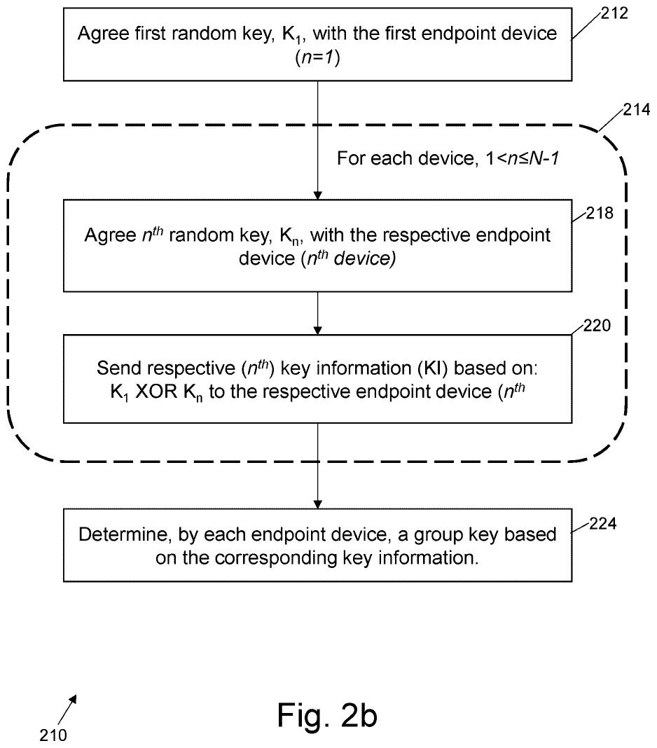

Importantly, the other QKD key, Kₘ, upon which the respective key information is based in part should be the same QKD key for each of the endpoint devices 102a-102n. For example, as discussed below in relation to FIGS. 2a and 2b, the other QKD, Kₘ, may be the first QKD key, K₁. However, as the skilled person will appreciate—and as is expanded upon in the description of further embodiments below—other implementations are possible and indeed may be desirable depending on the particular requirements of the system being implemented.

Operation 122 comprises, subsequent to operations 118 and 120, determining whether the value of the index, n, is equal to or exceeds the number, N, of endpoint devices 102a-102n in the group of devices. If the value of the index, n, is less than the number, N, of endpoint devices 102a-102n (i.e., n<N) then the operation 114 is repeated. If, however, the value of the index, n, is greater than or equal to the number, N, of endpoint devices 102a-102n then the method proceeds to operation 124. In other words, operation 114 is iterated until every endpoint device 102a-102b has received a respective QKD key and, where applicable, respective group key information. Each iteration of operation 114 may be carried out consecutively or simultaneously.

Operation 124 comprises determining, by each endpoint device 102a-102n, a group key based on their respective QKD key and corresponding group key information. Determining the group key may involve a determination based, at least in part, on a combination of the respective QKD key and the corresponding group key information. Once the group key has been determined by each of the endpoint devices 102a-102n, secure communications within the group may be enabled.

FIG. 2a is a schematic diagram illustrating a satellite QKD (SQKD) system 200 for group key sharing based on the QKD system 100 of FIG. 1a.

In the example shown in FIG. 2a, a plurality of endpoint devices 102a-102n are associated with a plurality of user stations that form a group. The plurality of user stations may be geographically and/or logically distinct from one another. In the example shown in FIG. 2a, the intermediary device 104 is a trusted satellite. In some examples, the intermediary device 104 is a single satellite that passes over each of the user stations 102a-102n in turn during its orbit. In other examples, the intermediary device 104 may be a group (or constellation) of satellites in communication with each other and respectively in communication with different subsets of the user stations 102a-102n. Different satellites may both be in communication with the same user station, or each user station may be in communication with just one satellite from the constellation of satellites.

As discussed above, the satellite(s) is/are configured to communicate with each of the user stations 102a-102n over respective quantum communication channels 106a-1 to 106n-1 and respective classical communication channels 106a-2 to 106n-2. These communication channels may, for example, be optical channels. In such implementations, each of the user stations 102a-102n may therefore include an optical receiver, for example an optical ground receiver (OGR).

In the SQKD system 200 of FIG. 2a, the satellite 104 is a trusted member of the group and may be configured to agree respectively different quantum keys with each of the group user stations 102a-102n. In other words, the satellite 104 agrees, with each group user station 102a-102n over a corresponding quantum communication channel 106a-1 to 106n-1, a respective QKD key using an appropriate QKD protocol (for example the BB84 protocol or another similar protocol such as that devised by the inventor and published in earlier patents and patent application, referenced above).

In order to distribute a group key amongst each of the group user stations 102a-102n, one of the QKD keys agreed between the satellite 104 and each of the group user stations 102a-102n is selected by the satellite 104 and designated as the group key. In the example shown in FIG. 2a, the QKD selected to be the group key is the first QKD key, K₁, i.e., the QKD agreed between the satellite 104 and the first user station 102a over the first quantum communication channel 106a-1. In order to securely distribute the selected group key to each of the other user stations 102b-102n, the satellite 104 encrypts-for each user station 102b-102n other than the first user station 102a-a respective copy of the group key (i.e., the first QKD key, K₁) with the respective QKD key, Kₙ, agreed between the satellite 104 and the corresponding user station 102b-102n. Encrypting the selected group key K₁ with the respective QKD key Kₙmay involve performing an XOR operation, or similar, between the selected group key K₁ and the respective QKD key Kₙ. The XOR operation may be represented by the symbol ⊕ in the disclosure herein, particularly the accompanying drawings. The satellite 104 is further configured to then transmit the respective encrypted group key to the corresponding user station 102b-102n over the respective classical communication channel 106b-2 to 106n-2. In this way, each user station 102a-102n receives a copy of the group key, said copy having been encrypted with the respective QKD key that has been agreed between the satellite 104 and the particular user station 102a-102n. Clearly, when the selected group key is the QKD key agreed with that particular user station 102a (i.e., the situation for the first user station 102a) there is no need to further transmit a copy of the group key to that user station 102a because it has already been agreed upon with the satellite 104.

Upon receipt of the encrypted group key, each user station 102b-102n is able to decrypt their copy of the group key by using their respective QKD key Kₙthat they agreed with the satellite 104.

FIG. 2b is a flow diagram illustrating a QKD group key sharing process 210 for use in the SQKD system of FIG. 2a.

A first operation 212 comprises agreeing, by the intermediary device (satellite) 104, over a first quantum communication channel 106a-1, a first encryption key, K₁, with a first endpoint device (user station) 102a of the group of endpoint devices 102a-102n. This agreement over the first quantum communication channel 106a-1 effectively amounts to the quantum key distribution of the first encryption key, K₁.

Subsequently operation 214 is carried out for each of the other endpoint devices 102b-102n. Operation 214 itself comprises operations 218 and 220. Operation 214 is repeated for each of the endpoint devices 102b-102n other than the first endpoint device 102a.

Operation 218 comprises agreeing, by the intermediary device 106, a respective encryption key, Kₙ, with one of the other endpoint devices 102b-102n over the corresponding quantum communication channel 106b-1 to 106n-1. In other words, a second encryption key, K₂, is agreed with the second endpoint device 102b over the corresponding second quantum communication channel 106b-1 and so on such that a (general) n^{th} encryption key, Kₙ, is agreed with a respective n^{th} endpoint device 102n over a corresponding n^{th} quantum communication channel 106n-1. Agreeing a series of encryption keys with respective endpoint devices 102b-102n over the corresponding quantum communication channel 106b-1 to 106n-1, as discussed above, effectively results in the quantum key distribution of the plurality of encryption keys to their respective endpoint devices 102b-102n.

Operation 220 comprises sending, by the intermediary device 106, respective group key information, to each of the endpoint devices 102b-102n other than the first endpoint device 102a. In other words, a ‘second’ item of group key information is sent to the second endpoint device 102b over the corresponding second classical communication channel 106b-2 and so on such that a (general) n^{th} item of group key information is sent to a respective n^{th} endpoint device 102n over a corresponding n^{th} classical communication channel 106n-2. As discussed above, the respective group key information is based on the respective QKD key, Kₙ, and the first QKD key, K₁. The respective group key information is preferably the first QKD key, K₁, encrypted with the corresponding QKD key, Kₙ.

Operation 224 comprises determining, by each endpoint device 102a-102n, a group key based on their respective QKD key and corresponding group key information. Determining the group key may involve, by each of the endpoint devices 102b-102n other than the first endpoint device 102a, decrypting the respective key information with the corresponding QKD key, Kₙ, agreed with the intermediary device 104-in this case the satellite. Decrypting the respective key information may involve performing an XOR operation, or similar, between the respective group key information and the corresponding QKD key, Kₙ, to obtain the selected group key-said group key being the first QKD key, K₁, agreed with the first endpoint device 102a. Once the group key has been determined by each of the endpoint devices 102a-102n, secure communications within the group may be enabled.

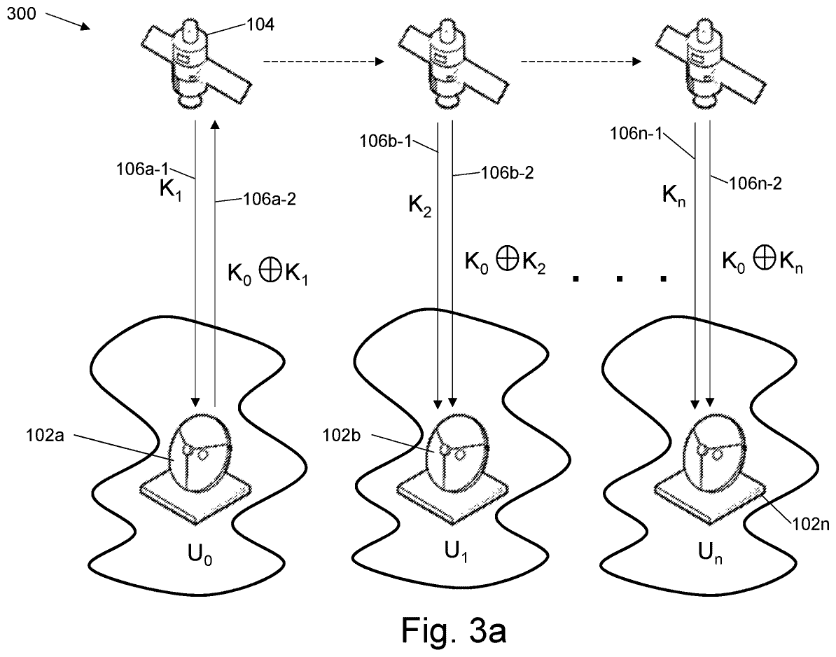

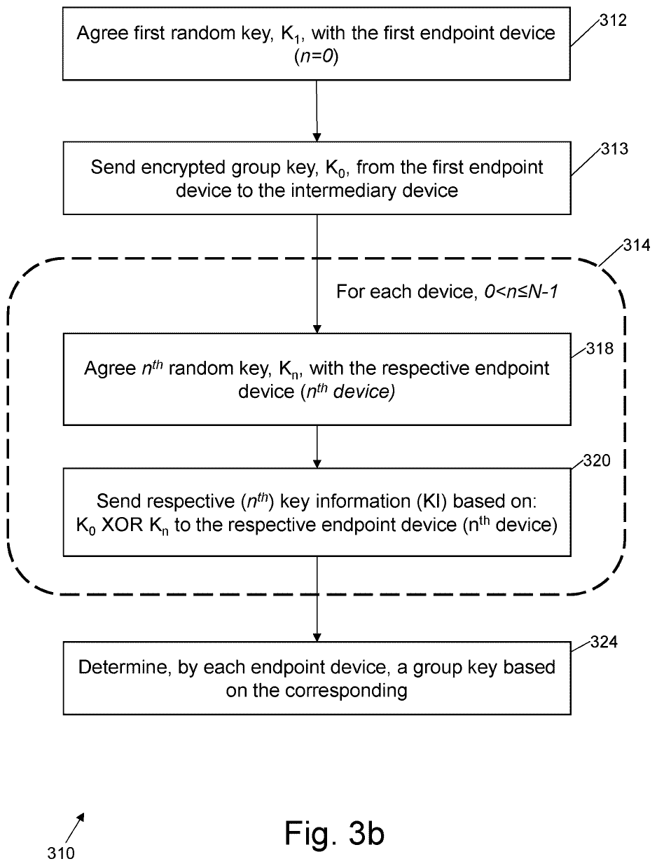

FIG. 3a is a schematic diagram illustrating another SQKD system 300 for group key sharing. Broadly speaking, the SQKD system 300 is similar to the SQKD system 200 described above in relation to FIG. 2a. Therefore, only the features differentiating the two SQKD systems 200, 300 will be discussed here.

The principal difference between the SQKD system 300 of FIG. 3a and the SQKD system 200 described above in relation to FIG. 2a is the origination and distribution of the group key. As discussed above, in the SQKD system 200 of FIG. 2a, the satellite 104 selects one of the QKD keys (e.g., the first QKD key, K₁) agreed between the satellite 104 and one of the endpoint devices 102a-102n (e.g., the first endpoint device 102a). In the example shown in FIG. 3a, however, the group key is created by one of the endpoint devices-in the depicted example by the first endpoint device 102a. The endpoint device 102a is configured to then encrypt the created group key, K₀, with the QKD key, K₁, agreed between said endpoint device 102a and the intermediary device/satellite 104. Encrypting the group key with the QKD key may involve, for example, performing an XOR operation, or similar, between the group key, K₀, and the (first) QKD key, K₁.

The endpoint device 102a is further configured to then send the encrypted group key, K₀, to the intermediary device/satellite 104. The intermediary device/satellite 104 is configured to, after receipt of the encrypted group key, decrypt the encrypted group key. Decrypting the group key may involve performing an XOR operation, or similar, between the encrypted group key and the (first) QKD key that was agreed between the intermediary device/satellite 104 and the (first) endpoint device 102a from which the encrypted group key was sent to the intermediary device/satellite 104. Once the group key has been successfully decrypted, the satellite is configured to encrypt copies of the group key, K₀, with each of the agreed QKD keys, Kₙ, and distribute the encrypted copies of the group key to each of the endpoint devices 102b-102n other than the first endpoint device 102a, as described above in relation to FIG. 2a—the main difference being that the selected group key is the group key, K₀, created by the first endpoint device 102a as opposed to the first QKD key, K₁, agreed between the intermediary device/satellite 104 and the first endpoint device 102a.

FIG. 3b is a flow diagram illustrating a QKD group key sharing process for use in the SQKD system of FIG. 3a.

A first operation 312 comprises agreeing, by the intermediary device (satellite) 104, over a first quantum communication channel 106a-1, a first encryption key, K₁, with a first endpoint device (user station) 102a of the group of endpoint devices 102a-102n. This agreement over the first quantum communication channel 106a-1 effectively amounts to the quantum key distribution of the first encryption key, K₁.

A second operation 313 comprises sending an encrypted group key from the first endpoint device 102a to the intermediary device/satellite 104. This may involve creating, by the first endpoint device 102a, the group key K₀ as described above, encrypting the group key with the first encryption key K₁and sending the encrypted group key to the intermediary device/satellite 104.

Preferably, in an operation not pictured in FIG. 3b, the intermediary device/satellite 104 decrypts and stores the group key, K₀.

Subsequently operation 314 is carried out for each of the other endpoint devices 102b-102n. Operation 214 itself comprises operations 318 and 320. Operation 314 is repeated for each of the endpoint devices 102b-102n other than the first endpoint device 102a.

Operation 318 comprises agreeing, by the intermediary device 106, a respective encryption key, Kₙ, with a respective one of the other endpoint devices 102b-102n over the corresponding quantum communication channel 106b-1 to 106n-1. In other words, a second encryption key, K2, is agreed with the second endpoint device 102b over the corresponding second quantum communication channel 106b-1 and so on such that a (general) n^{th} encryption key, Kₙ, is agreed with a respective n^{th} endpoint device 102n over a corresponding n^{th} quantum communication channel 106n-1. Agreeing a series of encryption keys with respective endpoint devices 102b-102n over the corresponding quantum communication channel 106b-1 to 106n-1, as discussed above, effectively results in the quantum key distribution of the plurality of encryption keys to their respective endpoint devices 102b-102n.

Operation 320 comprises sending, by the intermediary device 106, respective group key information, to a respective one of the endpoint devices 102b-102n other than the first endpoint device 102a. In other words, a ‘second’ item of group key information is sent to the second endpoint device 102b over the corresponding second classical communication channel 106b-2 and so on such that a (general) n^{th} item of group key information is sent to a respective n^{th} endpoint device 102n over a corresponding n^{th} classical communication channel 106n-2. As discussed above, the respective group key information is based on the respective QKD key, Kₙ, and the group key, K₀. The respective group key information is preferably the group key, K₀, encrypted with the corresponding QKD key, Kₙ.

Operation 324 comprises determining, by each endpoint device 102a-102n, the identity of the group key, K₀, based on their respective QKD key and corresponding group key information. Determining the group key may involve, by each of the endpoint devices 102b-102n other than the first endpoint device 102a, decrypting the respective key information with the corresponding QKD key, Kₙ, agreed with the intermediary device 104-in this case the satellite. Decrypting the respective key information may involve performing an XOR operation, or similar, between the respective group key information and the corresponding QKD key, Kₙ, to obtain the selected group key-said group key being the group key, K₀, created by the first endpoint device 102a. Once the group key has been determined by each of the endpoint devices 102a-102n, secure communications within the group may be enabled.

In the systems and methods described above in relation to FIGS. 2a to 3b, the intermediary device/satellite 104 possesses a copy of the group key. Therefore, for group communications to be secure, it is necessary for the satellite 204 to be a fully trusted part of the system. In other examples, such as those described below, it may not be necessary for the intermediary device/satellite 104 to be a trusted member of the group.

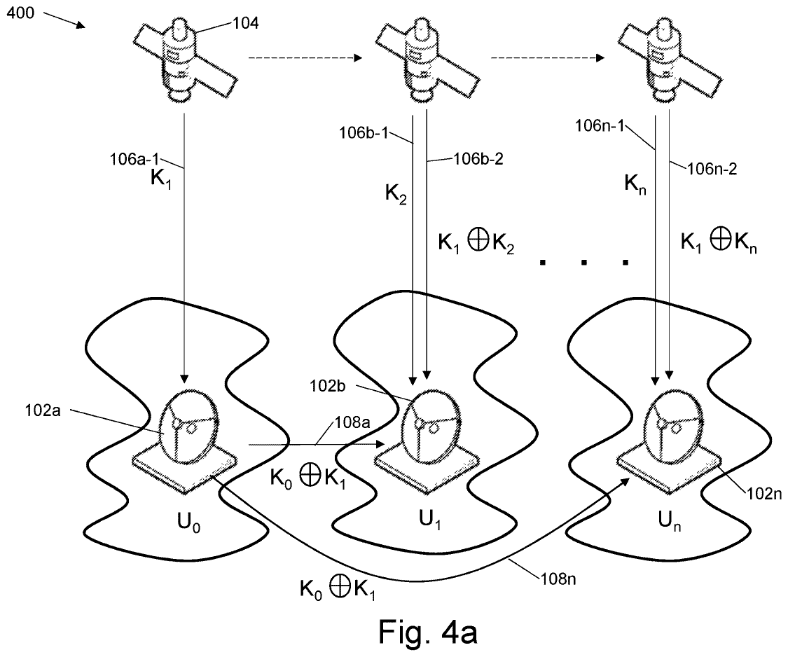

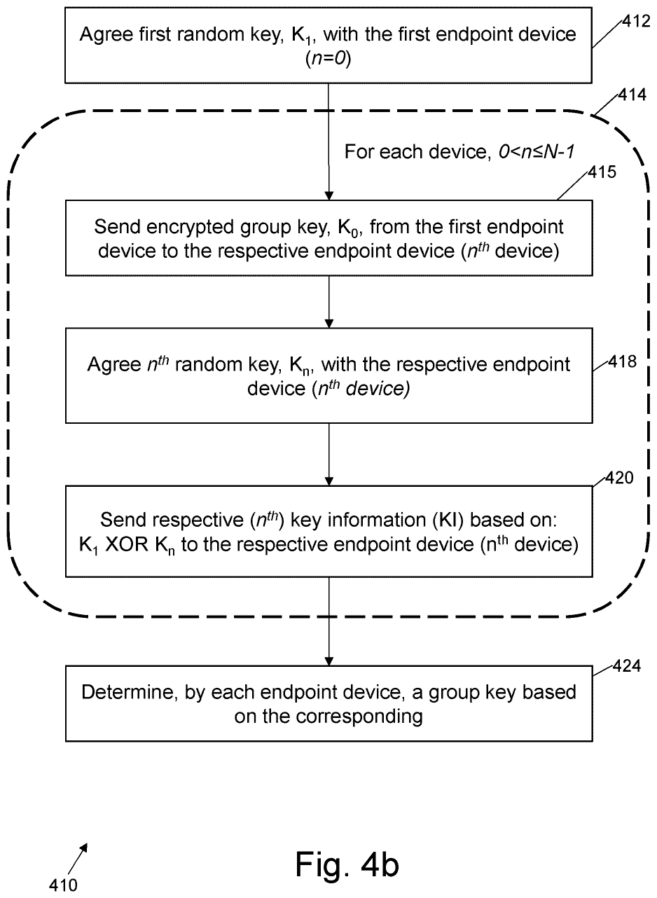

FIG. 4a is a schematic diagram illustrating another SQKD system 400 for group key sharing. Broadly speaking, the SQKD system 400 is similar to the SQKD systems 200, 300 described above in relation to FIGS. 2a and 3a. Therefore, only the features differentiating the SQKD system 400 shown in FIG. 4a from the SQKD systems 200, 300 shown in FIGS. 2a and 3a will be discussed here.

Similar to the SQKD system 300 described above in relation to FIG. 3a, in the SQKD system 400 of FIG. 4a, the group key, K₀, is created by one of the endpoint devices-in the depicted example this is the first endpoint device 102a (for illustrative purposes). The endpoint device 102a is configured to then encrypt the created group key, K₀, with the QKD key, K₁, agreed between said endpoint device 102a and the intermediary device/satellite 104. Encrypted the group key with the QKD key may involve, for example, performing an XOR operation, or similar, between the group key, K₀, and the (first) QKD key, K₁.

In contrast to the SQKD systems 200, 300 described above in relation to FIGS. 2a and 3a, the satellite/intermediary device 104 in the SQKD system 400 of FIG. 4 a is not a trusted member of the group. Therefore, it is a crucial part of the SQKD protocol that the satellite/intermediary device 104 is not privy to the details (i.e., the identity) of the group key K₀. Therefore, the first endpoint device 102a, i.e., the endpoint device that has created the group key, K₀, sends the encrypted group key (having been encrypted with the first QKD key, K₁) to each of the other endpoint devices 102b-102n over corresponding inter-endpoint communication channels 108a-108m. The corresponding inter-endpoint communication channels 108a-108m may preferably be classical communication channels, including, for example direct inter-party communication channels and/or broadcasting communication channels.

Meanwhile, the satellite/intermediary device 104 agrees a respective encryption key, K₂ . . . Kₙ, with each of the other endpoint devices 102b-102n over a corresponding quantum communication channel 106b-1 to 106n-1, in line with the methods and systems described above.

Subsequent to agreeing a respective encryption key, also referred to as a respective QKD key, with each endpoint device, the satellite/intermediary device 104 is configured to send respective group key information to each of the endpoint devices 102b-102n (other than the first endpoint device 102a). In the example shown in FIG. 4a, the respective key information is based on a combination of the respective QKD key, Kₙ, agreed with the corresponding endpoint device 102b-102n and the first QKD key, K₁, agreed between the satellite/intermediary device 104 and the first endpoint device 102a that created the group key, K₀. For example, the respective group key information may be a copy of the first QKD key, K₁, encrypted with the respective QKD key, Kₙ. The respective group key information may be transmitted over a classical communication channel 106b-2 to 106n-2 between the satellite/intermediary device 104 and the corresponding endpoint device 102b-102n.

The endpoint device 102a is further configured to then send the encrypted group key, K₀, to the intermediary device/satellite 104. The intermediary device/satellite 104 is configured to, after receipt of the encrypted group key, decrypt the encrypted group key. Decrypting the group key may involve performing and XOR operation, or similar, between the encrypted group key and the (first) QKD key that was agreed between the intermediary device/satellite 104 and the (first) endpoint device 102a from which the encrypted group key was sent to the intermediary device/satellite 104. Once the group key has been successfully decrypted, the satellite is configured to encrypt copies of the group key, K₀, with each of the agreed QKD keys, Kₙ, and distribute the encrypted copies of the group key to each of the endpoint devices 102b-102n other than the first endpoint device 102a, as described above in relation to FIG. 2a—the main difference being that the selected group key is the group key, K₀, created by the first endpoint device 102a as opposed to the first QKD key, K₁, agreed between the intermediary device/satellite 104 and the first endpoint device 102a.

Each endpoint device 102b-102n is able to determine the identity of the first QKD key, K₁, by retrieving the first QKD key from the corresponding key information, for example by using the QKD key that said endpoint device 102b-102n agreed with the satellite/intermediary device 104 to decrypt the group key information received from the satellite/intermediary device.

Armed with the identity of the first QKD key, K₁, each endpoint device 102b-102n is then able to decrypt the encrypted group key that they have received from the first endpoint device 102a to obtain the group key, K₀. As will be apparent, in this example, the satellite/intermediary device 104 is never provided with any of the information necessary to be able to derive the identity of the group key, K₀. In other words, the satellite/intermediary 104 is not a trusted member of the group of endpoint devices 102a-102n.

FIG. 4b is a flow diagram illustrating a QKD group key sharing process for use in the SQKD system of FIG. 4a.

A first operation 412 comprises agreeing, by the intermediary device (satellite) 104, over a first quantum communication channel 106a-1, a first encryption key, K₁, with a first endpoint device (user station) 102a of the group of endpoint devices 102a-102n. This agreement over the first quantum communication channel 106a-1 effectively amounts to the quantum key distribution of the first encryption key, K₁.

Subsequently, operation 414 is carried out for each of the other endpoint devices 102b-120n. Operation 414 itself comprises operations 415, 418 and 420. Operation 414 is repeated for each of the endpoint devices 102b-102n other than the first endpoint device 102a.

Operation 415 comprises sending a copy of an encrypted group key from the first endpoint device 102a to a respective one of the other endpoint devices 102b-102n. This may involve creating, by the first endpoint device 102a, the group key K₀ as described above, encrypting the group key with the first encryption key K₁ and sending the encrypted group key to a respective one of the other endpoint devices 102b-102n.

Operation 418 comprises agreeing, by the intermediary device 106, a respective encryption key, Kₙ, with one of the other endpoint devices 102b-102n over the corresponding quantum communication channel 106b-1 to 106n-1. In other words, a second encryption key, K₂, is agreed with the second endpoint device 102b over the corresponding second quantum communication channel 106b-1 and so on such that a (general) n^{th} encryption key, Kₙ, is agreed with a respective n^{th} endpoint device 102n over a corresponding n^{th} quantum communication channel 106n-1. Agreeing a series of encryption keys with respective endpoint devices 102b-102n over the corresponding quantum communication channel 106b-1 to 106n-1, as discussed above, effectively results in the quantum key distribution of the plurality of encryption keys to their respective endpoint devices 102b-102n.

Operation 420 comprises sending, by the intermediary device 106, respective group key information, to a respective one of the endpoint devices 102b-102n other than the first endpoint device 102a. In other words, a ‘second’ item of group key information is sent to the second endpoint device 102b over the corresponding second classical communication channel 106b-2 and so on such that a (general) n^{th} item of group key information is sent to a respective n^{th} endpoint device 102n over a corresponding n^{th} classical communication channel 106n-2. As discussed above, the respective group key information is based on the respective QKD key, Kₙ, and the first QKD key, K₁, i.e., the encryption key agreed between the first endpoint device 102a and the intermediary device/satellite 104. The respective group key information is preferably the first QKD key, K₁, encrypted with the corresponding QKD key, Kₙ.

Operation 424 comprises determining, by each endpoint device 102a-102n, the identity of the group key, K₀, based on their respective QKD key and corresponding group key information. Determining the group key may involve, by each of the endpoint devices 102b-102n other than the first endpoint device 102a, decrypting the respective key information with the corresponding QKD key, Kₙ, agreed with the intermediary device 104-in this case the satellite. Decrypting the respective key information may involve performing an XOR operation, or similar, between the respective group key information and the corresponding QKD key, Kₙ, to obtain the first QKD key, K₁. Each endpoint device 102a-102n may then decrypt their copy of the encrypted group key using the first QKD key (whose identity each of the endpoint devices 102a-102n has just obtained). Decrypting the copy of the encrypted group key may involve performing an XOR operation, or similar, between the copy of the encrypted group key and the first QKD key K₁ to obtain the selected group key-said group key being the group key, K₀, created by the first endpoint device 102a. Once the group key has been determined by each of the endpoint devices 102a-102n, secure communications within the group may be enabled.

As mentioned above, in the examples discussed above in relation to FIGS. 4a and 4b, it may not be necessary for the intermediary device/satellite 104 to be a trusted member of the group.

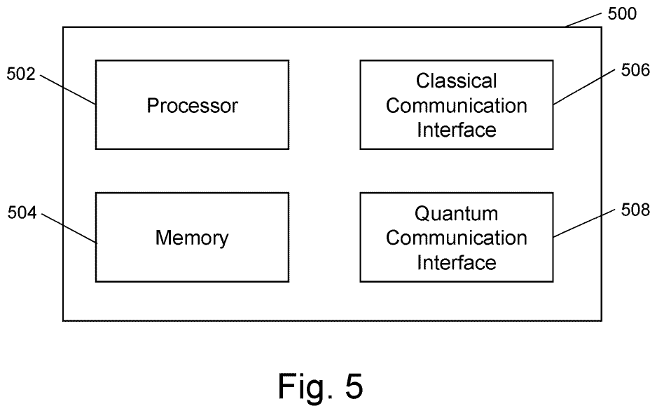

FIG. 5 is a schematic diagram illustrating an example computing device 500 configured to implement the methods described herein.

Computing device 500 comprises one or more processors 502, memory 504 and classical and quantum communication interfaces 506, 508. The computing device 500 may further comprise a random number generator or similar (not pictured) to facilitate generating random strings of bits to act as the encryption keys, Kₙ. The processor 502 may comprise executable logic that, when executed by the processor 502, causes the computing device 500 to carry out steps of the methods described herein. The memory 504 may be used to store information, for example the keys, basis sets, and group key information described above. The classical communication interface 506 may be configured for communicating over classical communications networks and/or satellite networks and the quantum communication interface 508 may be configured for communicating over quantum communication channels, for example using optical channels or other types of quantum channel. The communication interfaces 506, 508 may facilitate the communication of the keys, basis sets and group key information described above to enable the methods described herein.

In the embodiments described above, the server may comprise a single server or network of servers. In some examples, the functionality of the server may be provided by a network of servers distributed across a geographical area, such as a worldwide distributed network of servers, and a user may be connected to an appropriate one of the network servers based upon, for example, a user location.

The embodiments described above are fully automatic. In some examples a user or operator of the system may manually instruct some steps of the method to be carried out.

In the described embodiments of the invention the system may be implemented as any form of a computing and/or electronic device. Such a device may comprise one or more processors which may be microprocessors, controllers or any other suitable type of processors for processing computer executable instructions to control the operation of the device in order to gather and record routing information. In some examples, for example where a system on a chip architecture is used, the processors may include one or more fixed function blocks (also referred to as accelerators) which implement a part of the method in hardware (rather than software or firmware). Platform software comprising an operating system or any other suitable platform software may be provided at the computing-based device to enable application software to be executed on the device.

Various functions described herein can be implemented in hardware, software, or any combination thereof. If implemented in software, the functions can be stored on or transmitted over as one or more instructions or code on a computer-readable medium. Computer-readable media may include, for example, computer-readable storage media. Computer-readable storage media may include volatile or non-volatile, removable or non-removable media implemented in any method or technology for storage of information such as computer readable instructions, data structures, program modules or other data. A computer-readable storage media can be any available storage media that may be accessed by a computer. By way of example, and not limitation, such computer-readable storage media may comprise RAM, ROM, EEPROM, flash memory or other memory devices, CD-ROM or other optical disc storage, magnetic disc storage or other magnetic storage devices, or any other medium that can be used to carry or store desired program code in the form of instructions or data structures and that can be accessed by a computer. Disc and disk, as used herein, include compact disc (CD), laser disc, optical disc, digital versatile disc (DVD), floppy disk, and Blu-ray® disc (BD). Further, a propagated signal is not included within the scope of computer-readable storage media. Computer-readable media also includes communication media including any medium that facilitates transfer of a computer program from one place to another. A connection, for instance, can be a communication medium. For example, if the software is transmitted from a website, server, or other remote source using a coaxial cable, fibre optic cable, twisted pair, DSL, or wireless technologies such as infrared, radio, and microwave are included in the definition of communication medium. Combinations of the above should also be included within the scope of computer-readable media.

Alternatively, or in addition, the functionality described herein can be performed, at least in part, by one or more hardware logic components. For example, and without limitation, hardware logic components that can be used may include Field-programmable Gate Arrays (FPGAS), Program-specific Integrated Circuits (ASICs), Program-specific Standard Products (ASSPs), System-on-a-chip systems (SOCs). Complex Programmable Logic Devices (CPLDs), etc.

Although illustrated as a single system, it is to be understood that the computing device may be a distributed system. Thus, for instance, several devices may be in communication by way of a network connection and may collectively perform tasks described as being performed by the computing device.

Although illustrated as local devices it will be appreciated that the computing devices may be located remotely and accessed via a network or other communication link (for example using a communication interface).

The term ‘computer’ is used herein to refer to any device with processing capability such that it can execute instructions. Those skilled in the art will realise that such processing capabilities are incorporated into many different devices and therefore the term ‘computer’ includes PCs, servers, mobile telephones, personal digital assistants and many other devices.

Those skilled in the art will realise that storage devices utilised to store program instructions can be distributed across a network. For example, a remote computer may store an example of the process described as software. A local or terminal computer may access the remote computer and download a part or all of the software to run the program. Alternatively, the local computer may download pieces of the software as needed, or execute some software instructions at the local terminal and some at the remote computer (or computer network). Those skilled in the art will also realise that by utilising conventional techniques known to those skilled in the art that all, or a portion of the software instructions may be carried out by a dedicated circuit, such as a DSP, programmable logic array, or the like.

It will be understood that the benefits and advantages described above may relate to one embodiment or may relate to several embodiments. The embodiments are not limited to those that solve any or all of the stated problems or those that have any or all of the stated benefits and advantages. Variants should be considered to be included into the scope of the invention.

Any reference to ‘an’ item refers to one or more of those items. The term ‘comprising’ is used herein to mean including the method steps or elements identified, but that such steps or elements do not comprise an exclusive list and a method or apparatus may contain additional steps or elements.

As used herein, the terms “component” and “system” are intended to encompass computer-readable data storage that is configured with computer-executable instructions that cause certain functionality to be performed when executed by a processor. The computer-executable instructions may include a routine, a function, or the like. It is also to be understood that a component or system may be localized on a single device or distributed across several devices.

Further, to the extent that the term “includes” is used in either the detailed description or the claims, such term is intended to be inclusive in a manner similar to the term “comprising” as “comprising” is interpreted when employed as a transitional word in a claim.

Moreover, the acts described herein may comprise computer-executable instructions that can be implemented by one or more processors and/or stored on a computer-readable medium or media. The computer-executable instructions can include routines, sub-routines, programs, threads of execution, and/or the like. Still further, results of acts of the methods can be stored in a computer-readable medium, displayed on a display device, and/or the like.

The order of the steps of the methods described herein is exemplary, but the steps may be carried out in any suitable order, or simultaneously where appropriate. Additionally, steps may be added or substituted in, or individual steps may be deleted from any of the methods without departing from the scope of the subject matter described herein. Aspects of any of the examples described above may be combined with aspects of any of the other examples described to form further examples without losing the effect sought.

It will be understood that the above description of a preferred embodiment is given by way of example only and that various modifications may be made by those skilled in the art. What has been described above includes examples of one or more embodiments. It is, of course, not possible to describe every conceivable modification and alteration of the above devices or methods for purposes of describing the aforementioned aspects, but one of ordinary skill in the art can recognize that many further modifications and permutations of various aspects are possible. Accordingly, the described aspects are intended to embrace all such alterations, modifications, and variations that fall within the scope of the appended claims.

1-53. (canceled)

54. A computer-implemented method of generating a group key for a group of endpoint devices in a communication system comprising the group of endpoint devices and an intermediary device, the intermediary device being communicatively linked to each of the endpoint devices by a respective quantum communication channel and a respective classical communication channel, the method comprising:
agreeing, between the intermediary device and each of the endpoint devices, a respective QKD key, Kₙ, over the corresponding quantum communication channel;
determining a group key for secure communication within the group of endpoint devices;
sending, from the intermediary device to each of the endpoint devices over the corresponding classical communication channel, respective group key information,
wherein the respective group key information comprises information useable by the corresponding endpoint device to derive an identity of the group key, said information being encrypted with the respective QKD key agreed between the intermediary device and the corresponding endpoint device; and
deriving, by each of the endpoint devices, the identity of the group key.

55. The computer-implemented method according to claim 54, wherein:
the group of endpoint devices further comprises a first endpoint device;
determining the group key comprises determining the group key at the first endpoint device; and
respective group key information is not sent to the first endpoint device.

56. The computer-implemented method according to claim 55, wherein determining the group key comprises: determining that the QKD key agreed between a or the first endpoint device and the intermediary device is the group key.

57. The computer-implemented method according to claim 54, wherein the information useable to derive the identity of the group key comprises the group key.

58. The computer-implemented method according to claim 55, wherein determining the group key comprises: determining a new encryption key, K₀, as being the group key.

59. The computer-implemented method according to claim 58, wherein the new encryption key, K₀, is a randomly generated string of bits.

60. The computer-implemented method according to claim 58, further comprising:
sending, from the first endpoint device to the intermediary device, a copy of the group key, K₀, encrypted with the QKD key agreed between the first endpoint device and the intermediary device; and
creating, by the intermediary device, the respective group key information to be sent to each endpoint device other than the first endpoint device, wherein the respective group key information comprises the group key.

61. The computer-implemented method according to claim 60, further comprising: after receiving an encrypted copy of the encryption key, and before creating the respective group key information:
decrypting the encrypted copy of the group key to obtain a copy of the group key, K₀.

62. The computer-implemented method according to claim 60, wherein encrypting and/or decrypting the copy of the group key comprises performing an XOR operation of the group key or encrypted group key with the QKD key agreed between the first endpoint device and the intermediary device.

63. The computer-implemented method according to claim 58, further comprising:
sending, from the first endpoint device to each of the other endpoint devices over corresponding inter-endpoint device communication channels, a copy of the group key, K₀, encrypted with the QKD key agreed between the first endpoint device and the intermediary device,
wherein the information useable to derive the identity of the group key comprises the QKD key agreed between the first endpoint device and the intermediary device.

64. The computer-implemented method according to claim 63, wherein deriving, by each of the endpoint devices other than the first endpoint device, the identity of the group key comprises:
obtaining, based on the respective group key information and the respective QKD key, a copy of the QKD key agreed between the first endpoint device and the intermediary device; and
deriving the identity of the group key from an encrypted copy of the group key received from the first endpoint device based on the copy of the QKD key agreed between the first endpoint device and the intermediary device.

65. The computer-implemented method according to claim 63, wherein encrypting and/or decrypting each copy of the group key, K₀, sent from the first endpoint device to each of the other endpoint devices comprises performing an XOR operation between the copy of the group key and the QKD key agreed between the first endpoint device and the intermediary device.

66. The computer-implemented method according to claim 63, wherein the inter-endpoint device communication channels are classical communication channels.

67. The computer-implemented method according to claim 54, wherein the information useable to derive the identity of the group key within the respective group key information is encrypted with the respective QKD key.

68. The computer-implemented method according to claim 67, wherein the information useable to derive the identity of the group key is encrypted by performing an XOR operation of said information with the respective QKD key.

69. The computer-implemented method according to claim 67, wherein deriving the identity of the group key comprises decrypting, by each of the endpoint devices, the respectively received group key information using the respective QKD key agreed between the intermediary device and the corresponding endpoint device.

70. The computer-implemented method according to claim 69, wherein decrypting the respectively received group key information comprises performing an XOR operation of the respectively received group key information and the respective QKD key agreed between the intermediary device and the corresponding endpoint device.

71. A computer-implemented method for generating a group key for a group of endpoint devices in a communication system, the method being performable by an intermediary device communicatively linked to each of the endpoint devices by a respective quantum communication channel and a respective classical communication channel, the method comprising:
agreeing, with each of the endpoint devices, a respective QKD key, Kₙ, over the corresponding quantum communication channel; and
sending, to each of the endpoint devices, over the corresponding classical communication channel, respective group key information,
wherein the group key information comprises information useable by the corresponding endpoint device to derive an identity of a group key, said information being encrypted with the respective QKD key agreed between the intermediary device and the corresponding endpoint device, and
wherein the group key is useable for secure communication within the group of endpoint devices.

72. The computer-implemented method according to claim 71, further comprising determining a group key for secure communication within the group of endpoint devices.

73. A computer-implemented method for generating a group key for a group of endpoint devices in a communication system, the method being performable by an endpoint device in the group, said endpoint device being communicatively linked to an intermediary device by a quantum communication channel and a classical communication channel, the method comprising:
agreeing, with the intermediary device, a QKD key, Kₙ, over the quantum communication channel; and
either:
determining a group key for secure communication within the group of endpoint devices;
or:
receiving, from the intermediary device, over the classical communication channel, group key information,
wherein the group key information comprises information useable by the endpoint device to derive an identity of a group key for secure communication within the group of endpoint devices, said information being encrypted with the QKD key, and
deriving the identity of the group key.
